(19) United States
(12) Patent Application Publication
(10) Pub. No.: US 2005/0256971 A1
(43) Pub. Date: Nov. 17, 2005

(54) Runtime load balancing of work across a clustered computing system using current service performance levels

(75) Inventors: Carol Colrain, Redwood Shores, CA (US); Charles Simmons, Redwood City, CA (US); Daniel Semler, Belmont, CA (US); Stefan Pommerenk, Hayward, CA (US); Angelo Pruscino, Los Altos, CA (US)

Correspondence Address: HICKMAN PALERMO TRUONG & BECKER/ORACLE, 2055 GATEWAY PLACE, SUITE 550, SAN JOSE, CA, 95110-1089, US

(73) Assignee: ORACLE INTERNATIONAL CORPORATION, REDWOOD SHORES, CA (US)

(21) Appl. No.: 11/168,967

(22) Filed: Jun. 27, 2005

Related U.S. Application Data
(63) Continuation-in-part of application No. 10/917,715, filed on Aug. 12, 2004.
(60) Provisional application No. 60/652,368, filed on Feb. 11, 2005.
(60) Provisional application No. 60/495,368, filed on Aug. 14, 2003.
(60) Provisional application No. 60/500,096, filed on Sep. 3, 2003.

(51) Int. Cl. G06F 7/00

(52) U.S. Cl. 709/238

(57) ABSTRACT

Runtime load balancing of work across a clustered computing system involves servers calculating, and clients utilizing, current service performance grades of each instance in the system. A performance grade for an instance is based on performance metrics for that instance, where the computation used may vary by policy. Examples of possible policies include: (a) using estimated bandwidth as a performance grade, (b) using spare capacity as a performance grade, or (c) using response time as a performance grade. Clients distribute work requests across servers in the system as the requests arrive. Work requests can be distributed according to performance grades, and/or flags associated with the performance grades. Automatically and intelligently directing work requests to the best server instances, based on real-time service performance metrics, minimizes the need to manually relocate work within the clustered system.

### CROSS REFERENCE TO RELATED APPLICATIONS

This application is a continuation-in-part of and claims the benefit of priority to U.S. patent application Ser. No. 10/917,715 filed on Aug. 12, 2004, entitled “Managing Workload By Service”, which claims the benefit of priority to U.S. Provisional Patent Application No. 60/500,096 filed on Sep. 3, 2003, entitled “Service Based Workload Management and Measurement In a Distributed System.”

This application claims the benefit of priority to U.S. Provisional Patent Application No. 60/652,368 filed on Feb. 11, 2005, entitled “Runtime Load Balancing Based on Service Level Performance”; the content of all of which is incorporated by this reference in its entirety for all purposes as if fully set forth herein.

This application is related to the following applications, the contents of all of which are incorporated by this reference in their entirety for all purposes as if fully set forth herein:
U.S. patent application Ser. No. 10/917,663 filed on Aug. 12, 2004, entitled “Fast Reorganization Of Connections In Response To An Event In A Clustered Computing System”;
U.S. application Ser. No. 10/917,661 filed on Aug. 12, 2004, entitled “Calculation of Service Performance Grades in a Multi-Node Environment That Hosts the Services”;
U.S. patent application Ser. No. 11/XXX,XXX (Docket No. 50277-2735), filed on the same day herewith, entitled “Connection Pool Use Of Runtime Load Balancing Performance Advisories”.

### FIELD OF THE INVENTION

The present invention relates generally to distributed computing systems and, more specifically, to techniques for runtime load balancing of work across a distributed computing system using current service performance grades.

### BACKGROUND OF THE INVENTION

Many enterprise data processing systems rely on distributed database servers to store and manage data. Such enterprise data processing systems typically follow a multi-tier model that has a distributed database server in the first tier, one or more computers in the middle tier linked to the database server via a network, and one or more clients in the outer tier.

Clustered Computing System

A clustered computing system is a collection of interconnected computing elements that provide processing to a set of client applications. Each of the computing elements is referred to as a node. A node may be a computer interconnected to other computers, or a server blade interconnected to other server blades in a grid. A group of nodes in a clustered computing system that have shared access to storage (e.g., have shared disk access to a set of disk drives or non-volatile storage) and that are connected via interconnects is referred to herein as a work cluster.

A clustered computing system is used to host clustered servers. A server is combination of integrated software components and an allocation of computational resources, such as memory, a node, and processes on the node for executing the integrated software components on a processor, where the combination of the software and computational resources are dedicated to providing a particular type of function on behalf of clients of the server. An example of a server is a database server. Among other functions of database management, a database server governs and facilitates access to a particular database, processing requests by clients to access the database.

Resources from multiple nodes in a clustered computing system can be allocated to running a server's software. Each allocation of the resources of a particular node for the server is referred to herein as a “server instance” or instance. A database server can be clustered, where the server instances may be collectively referred to as a cluster. Each instance of a database server facilitates access to the same database, in which the integrity of the data is managed by a global lock manager.

Services for Managing Applications According to Service Levels

Services are a feature for database workload management that divide the universe of work executing in the database, to manage work according to service levels. Resources are allocated to a service according to service levels and priority. Services are measured and managed to efficiently deliver the resource capacity on demand. High availability service levels use the reliability of redundant parts of the cluster.

Services are a logical abstraction for managing workloads. Services can be used to divide work executing in a database cluster into mutually disjoint classes. Each service can represent a logical business function, e.g., a workload, with common attributes, service level thresholds, and priorities. The grouping of services is based on attributes of the work that might include the application function to be invoked, the priority of execution for the application function, the job class to be managed, or the data range used in the application function of a job class. For example, an electronic-business suite may define a service for each responsibility, such as general ledger, accounts receivable, order entry, and so on. Services provide a single system image to manage competing applications, and the services allow each workload to be managed in isolation and as a unit. A service can span multiple server instances in a cluster or multiple clusters in a grid, and a single server instance can support multiple services.

Middle tier and client/server applications can use a service, for example, by specifying the service as part of the connection. For example, application server data sources can be set to route to a service. In addition, server-side work sets the service name as part of the workload definition. For example, the service that a job class uses is defined when the job class is created, and during execution, jobs are assigned to job classes and job classes run within services.

Database Sessions

In order for a client to interact with a database server on a database cluster, a session is established for the client. Each session belongs to one service. A session, such as a database session, is a particular connection established from a client to a server, such as a database instance, through which the client issues a series of requests (e.g., requests for execution of database statements). For each database session established on a database instance, session state data is maintained that reflects the current state of a database session. Such information contains, for example, the identity of the client for which the session is established, the service used by the client, and temporary variable values generated by processes executing software within the database session. Each session may each have its own database process or may share database processes, with the latter referred to as multiplexing.

### BRIEF DESCRIPTION OF THE DRAWINGS

Embodiments of the present invention are depicted by way of example, and not by way of limitation, in the figures of the accompanying drawings and in which like reference numerals refer to similar elements and in which:

FIG. 1 is a block diagram that illustrates an operating environment in which an embodiment can be implemented;

FIG. 2 is a block diagram that illustrates a server operating environment, in which an embodiment of the invention may be implemented;

FIG. 3 is a flow diagram that illustrates a method for determining how much work to route to nodes in a distributed computing system, according to an embodiment; and

FIG. 4 is a block diagram that depicts a computer system upon which an embodiment of the invention may be implemented.

### DETAILED DESCRIPTION OF EMBODIMENTS OF THE INVENTION

Techniques for runtime load balancing of work across a distributed computing system are described. Such techniques compute and make available to client subscribers, current service level performance information and work distribution advisories, with which work routing decisions can be made. Service level performance information and work distribution advisories regarding the different instances of the system can be used to allow balancing of the work across the system.

Functional Overview of Embodiments

Runtime load balancing of work across a clustered computing system involves servers calculating, and clients utilizing, the current service performance levels of each instance in the system. Such performance levels (“performance grades”) are based on performance metrics, and corresponding percentage distribution advisories are posted for use by various types of client subscribers.

Within a multi-instance server, various performance metrics are gathered for each instance. These performance metrics may include operations completed per second, elapsed time per operation, CPU utilization, I/O utilization, network utilization, and the like. A moving average of the metrics is usually used in order to smooth out any short-term variations. In one embodiment, each instance within the server periodically sends its performance metrics to a centralized location.

The server then computes a performance grade for each instance. The computation used may vary by policy. Examples of possible policies include: (a) using estimated bandwidth as a performance grade, (b) using spare capacity as a performance grade, or (c) using response time as a performance grade. The server may compute a performance grade for each instance without regard to the performance of other instances, or the server may holistically look at all instances to produce a grade for each instance. The server publishes the performance grades of the instances to the client subscribers.

The performance grades may be used by clients to effectively route work to instances without regard to the number of client subscribers. In one embodiment, performance grades are posted via events, which can be subscribed to by many client subscribers. Non-limiting examples of subscribers include connection pools, load balancers, job schedulers, etc. Any client that wants to route service-based work within the system can use the runtime load balancing performance grades.

Using the described techniques, clients distribute work requests across servers in a clustered computing environment as the requests arrive. Work requests can be distributed according to performance grades, or the client may use other information available to the client to route the work. For example, the client may wish to route work to where the requestor last interacted (referred to as a “sticky” policy). Automatically and intelligently directing work requests to the best server instances, based on real-time service performance metrics, minimizes the need to manually relocate work within the clustered system.

In general, basing work request routing decisions on performance grades recognizes, for non-limiting examples, differences in various machine's current workload and computing power, sessions that are blocked in wait mode, failures that block processing, and competing services having different levels of priority. In other words, work requests are routed based on “bandwidth,” where the work distribution percentage of a node is proportional of that node's bandwidth to the total bandwidth of all nodes that can support the service whose load is being balanced. The bandwidth of a cluster, for example, is the sum of the bandwidths of the nodes in the cluster. There are a number of ways to estimate the bandwidth of a node. In one embodiment, node bandwidth is estimated by measuring the throughput of a service on a node in units of work completed per second, and to scale the throughput up by the unused capacity of the node.

Operating Environment

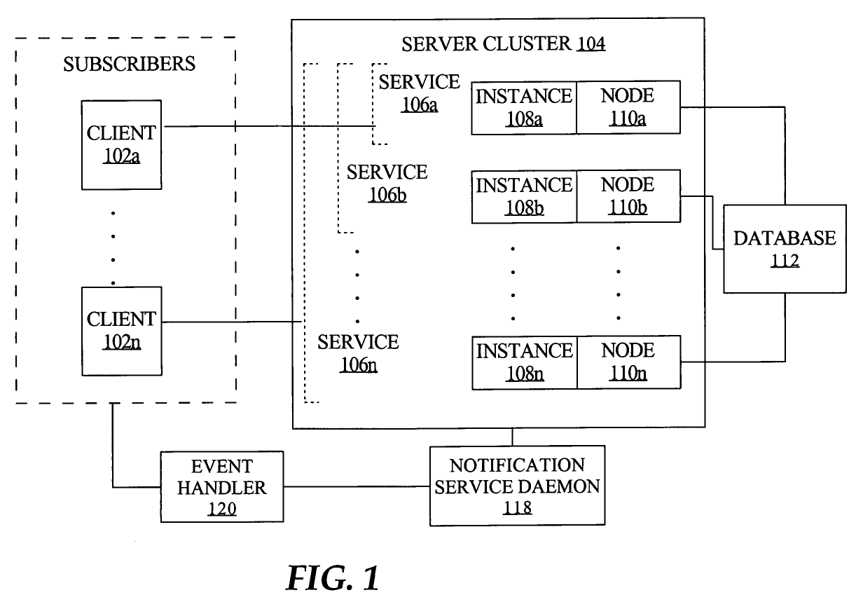

FIG. 1 is a block diagram that illustrates an operating environment in which an embodiment can be implemented. Use of element identifiers ranging from a to n, for example, clients 102a-102n, services 106a-106n, instances 108a-108n, and nodes 110a-110n, does not mean that the same number of such components are required. In other words, n is not necessarily equal for the respective components. Rather, such identifiers are used in a general sense in reference to multiple similar components.

Clustered Computing Environment

One or more clients 102a-102n are communicatively coupled to a server cluster 104 (“server”) that is connected to a shared database 112. Server 104 refers collectively to a cluster of server instances 108a-108n and nodes 110a-110n on which the instances execute. Other components may also be considered as part of the server 104, such as automatic workload repository 118. However, the actual architecture in which the foregoing components are configured may vary from implementation to implementation. Clients 102a-102n may be applications executed by computers interconnected to an application server or some other middleware component between clients and server 104 via, for example, a network. In addition, one server instance may be a client of another server instance. Any or all of clients 102a-102n may operate as subscribers of published events, as described herein.

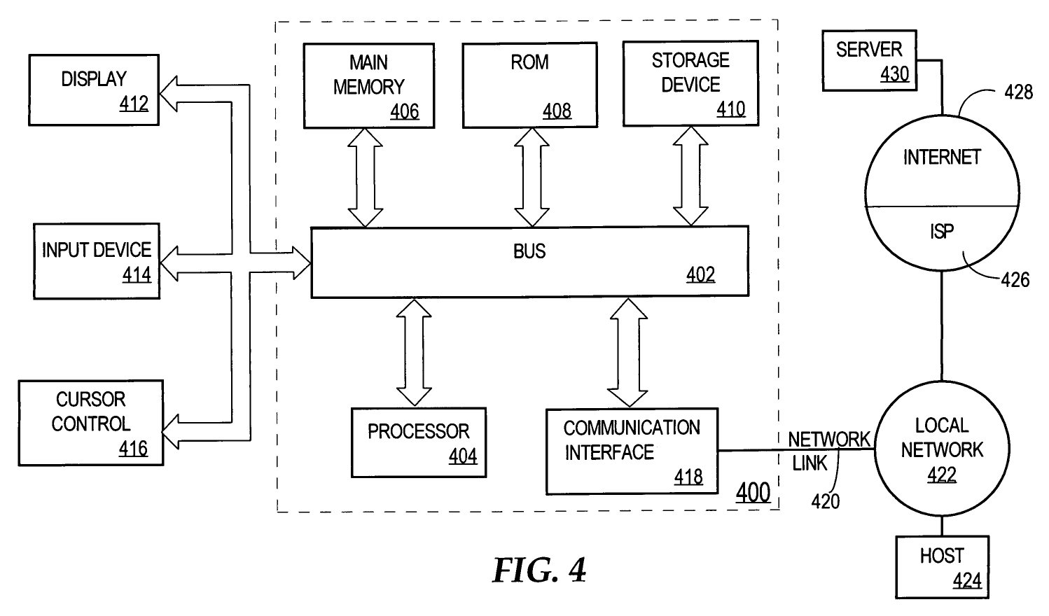

In the context of a database cluster, database 112 comprises data and metadata that is stored on a persistent memory mechanism, such as a set of hard disks that are communicatively coupled to nodes 110a-110n, each of which is able to host one or more instances 108a-108n, each of which hosts at least a portion of one or more services. Such data and metadata may be stored in database 112 logically, for example, according to relational database constructs, multidimensional database constructs, or a combination of relational and multidimensional database constructs. Nodes 110a-110n can be implemented as a conventional computer system, such as computer system 400 illustrated in FIG. 4.

As described, a database server is a combination of integrated software components and an allocation of computational resources (such as memory and processes) for executing the integrated software components on a processor, where the combination of the software and computational resources are used to manage a particular database, such as database 112. Among other functions of database management, a database server typically facilitates access to database 112 by processing requests from clients to access the database 112. Instances 108a-108n, in conjunction with respective nodes 110a-110n, host services 106a-106n.

Operating Environment-Server

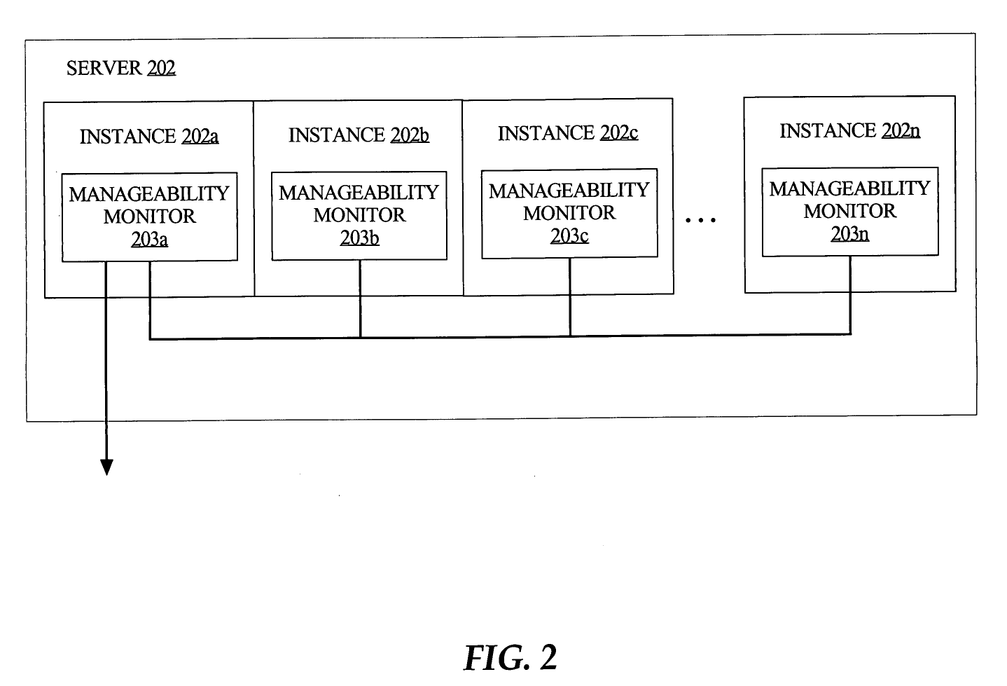

FIG. 2 is a block diagram that illustrates a server operating environment, in which an embodiment of the invention may be implemented. Server 202 operates similarly to server cluster 104 of FIG. 1, instances 202a-202n operate similarly to instances 108a-108n of FIG. 1. Therefore, unless otherwise stated, the descriptions and interrelationships of such components in reference to FIG. 1 apply to the similarly operating components depicted in FIG. 2.

FIG. 2 is referenced in describing, generally, the manner in which service performance is derived among a plurality of instances in a clustered computing environment. Each instance 202a, 202b, 202c, 202n comprises a respective manageability monitor (MMON) 203a, 203b, 203c, 203n. Each MMON 203a-203n is, in one embodiment, a dedicated manageability background process, which handles automatic management within the server 202. Using MMON, components in the server 202 can schedule periodic performance of system and service monitoring-type actions.

Each MMON 203a-203n periodically computes metric values and checks for occurrence of system events. MMONs 203a-203n are capable of comparing metric thresholds with actual values and generating alerts if necessary. MMONs 203a-203n can post service performance grades and advisories, for subscribing clients, via a notification system as described herein in reference to FIG. 1.

One MMON from the server 202 serves as a master, for metric collection and performance grade derivation purposes. For example, the instance with the lowest instance number may be elected as the master. In this illustration, MMON 203a of instance 202a is considered the master. The master periodically requests, from the other instance MMONs, the locally generated performance statistics. From that information, the master calculates a performance grade for each instance in the system, as described in more detail hereafter. The master then posts the derived performance grades to the clients, such as by writing to event queues. In one embodiment, the foregoing process is performed for all services running on the server 202 regardless of which instance(s) 202a-202n are providing a given service.

Services 106

As previously described herein, services are, generally, a logical abstraction for managing workloads. More specific to the context of embodiments of the invention, a service, such as service 106a-106n, has a name and a domain, and may have associated goals, service levels, priority, and high availability attributes. The work performed as part of a service includes any use or expenditure of computer resources, including, for example, CPU processing time, storing and accessing data in volatile memory, read and writes from and/or to persistent storage (i.e. disk space), and use of network or bus bandwidth.

In one embodiment, a service is work that is performed by a database server during a session, and typically includes the work performed to process and/or compute queries that require access to a particular database. The term query as used herein refers to a statement that conforms to a database language, such as SQL, and includes statements that specify operations to add, delete, or modify data and create and modify database objects, such as tables, objects views, and executable routines. A system, including a clustered computing system, may support many services.

Services can be provided by one or more database server instances. Thus, multiple server instances may work together to provide a service to a client. In FIG. 1, service 106a (e.g., FIN) is depicted, with dashed brackets, as being provided by instance 108a, service 106b (e.g., PAY) is depicted as being provided by instances 108a and 108b, and service 106n is depicted as being provided by instances 108a-108n.

Generally, the techniques described herein are as service-centric, where events occurring within server 104 can be identified and/or characterized based on the service(s) which is affected by the event. The payload of notification events is described hereafter.

Notification System

In one embodiment, a notification system as described hereafter is used to publish performance related information to client subscribers. However, how the performance information is published may vary from implementation to implementation, and is not limited to the notification system described.

In general, a daemon is a process that runs in the background and that performs a specified operation at predefined times or in response to certain events. In general, an event is an action or occurrence whose posting is detected by a process. Notification service daemon 118 is a process that receives alert and advisory information from server 104, such as from background manageability monitors that handle automatic management functions or clusterware that is configured to manage the cluster of instances 106a-106n. The server 104 posts service level performance events automatically and periodically, for subscribers to such events, such as runtime load balancing clients 102a-102n. In one embodiment, service level performance events are posted periodically based on the service request rate.

Notification service daemon 118 has a publisher-subscriber relationship with event handler 120 through which service performance information that is received by daemon 118 from server 104 is transmitted as work distribution advisory events to event handler 120. In general, an event handler is a function or method containing program statements that are executed in response to an event. In response to receiving event information from daemon 118, event handler 120 at least passes along the event type and attributes, which are described herein. A single event handler 120 is depicted in FIG. 1 as serving all subscribers. However, different event handlers may be associated with different subscribers. The manner in which handling of advisory events is implemented by various subscribers to such events is unimportant, and may vary from implementation to implementation.

For a non-limiting example, notification service daemon 118 may use the Oracle Notification System (ONS) API, which is a messaging mechanism that allows application components based on the Java 2 Platform, Enterprise Edition (J2EE) to create, send, receive, and read messages.

“Subscribers” represents various entities that may subscribe to and respond to notification events for various respective purposes. Non-limiting examples of subscribers include clients 102a-102n, connection pool managers, mid-tier applications, batch jobs, callouts, paging and alert mechanisms, high availability logs, and the like.

Server Derivation of Work Distribution

Service Measures

A performance metric is data that indicates the quality of performance realized by services, for one or more resources. A performance metric of a particular type that can be used to gauge a characteristic or condition that indicates a service level of performance is referred to herein as a service measure. Service measures include, for example, completed work per second, elapsed time for completed calls, resource consumption and resource demand, wait events, and the like, some of which are described in more detail herein. Service measures are automatically maintained, for every service.

One approach to generating performance metrics, including service-based performance metrics on which service measures are based, which may be used for load balancing across a database cluster, are described in U.S. patent application Ser. No. 10/917,715 filed on Aug. 12, 2004, entitled “Managing Workload By Service”, which is incorporated by this reference in its entirety for all purposes as if fully disclosed herein.

For example, a background process may generate performance metrics from performance statistics that are generated for each session and service hosted on a database instance. Like performance metrics, performance statistics can indicate a quality of performance. However, performance statistics, in general, include more detailed information about specific uses of specific resources. Performance statistics include, for example, how much time CPU time was used by a session, the throughput of a call, the number of calls a session made, the response time required to complete the calls for a session, how much CPU processing time was used to parse queries for the session, how much CPU processing time was used to execute queries, how many logical and physical reads were performed for the session, and wait times for input and output operations to various resources, such as wait times to read or write to a particular set of data blocks. Performance statistics generated for a session are aggregated by services and service subcategories (e.g. module, action) associated with the session.

Computing A Performance Grade

Performance grades can be computed in a variety of different ways. Generally, the server allows an administrator to specify a service level goal for each service. This goal defines which service measures are important for the service, e.g., response time measures or throughput measures. Within a service, it is generally assumed that clients will route work to instances in proportion to the performance grade of each instance. This section presents examples of performance grade computations.

When computing a performance grade, various problems can occur that may prevent the grade from being meaningful. Thus, in addition to supplying a performance grade, an enumerated value that describes additional information about the grade is also provided. The possible flags include:

GOOD—The performance grade was computed for this instance.

VIOLATING—The service on this instance is in violation of the service's service level agreement. For example, and administrator may have specified that the service should always provide a two second response time and the response time is currently averaging three seconds. In this case, the performance grade has been computed and is meaningfull.

NODATA—We may not have been able to obtain any performance metrics from an instance. For example, the instance may be in the process of crashing or it may be hung or otherwise unresponsive. This flag advises the client that we were unable to compute a performance grade, and the instance is probably not a good place to send work to.

UNKNOWN—During start up or during periods of low service utilization, we may not be able to compute a meaningful value for the performance grade. This flag indicates that we were unable to compute the performance grade, but that the instance is useable. In this case, the server would generally assume that this instance is pretty much the same as all the other GOOD or VIOLATING instances, and compute a performance grade based on that assumption.

In some cases, it is desirable to normalize a performance grade into a small range of values. This can be done by dividing the performance grade of each instance by the sum of the performance grades at all instances to obtain a value in the closed interval of [0, 1] for each instance. This value may be further scaled. For example, if this value is multiplied by 100, then the resulting value gives the percentage of the workload that should be handed to this instance.

Bandwidth

One service level goal may be to estimate the bandwidth of each instance, and publish that bandwidth as a performance grade. One way of estimating bandwidth is to measure the actual throughput of each instance and to estimate how busy the instance is. By definition, the bandwidth of an instance is the throughput that is obtained when the instance is 100% busy. Thus
Estimated Bandwidth=Throughput*100/% busy;
where “% busy” is a number in the half open interval (0, 100). Note that the UNKNOWN flag is used when either throughput or the estimated % busy is zero.

It is usually necessary to estimate how busy an instance is. One method is to measure how busy the CPU is. Other techniques include measuring how busy a specific resource class is, such as disk I/O or network bandwidth; or to use a weighted average across multiple resource classes.

It is common to use a moving average of both the throughput measurement (work completed per second) and the measurement of how busy the system is (e.g. CPU utilization).

When this goal is used, the system will attempt to balance the workload handed to each instance to be proportional to the bandwidth of the instance. That is, the system will attempt to keep the ratio throughput/bandwidth at each instance constant. Since throughput/bandwidth=throughput/throughput/% busy, this goal will attempt to make sure that % busy is constant across all nodes, i.e., all instances are kept relatively equally busy.

Response Time

Another service level goal may be to publish the response time of the service on an instance as the performance grade of the instance. Response time is a measure of the elapsed time from when a unit of work arrived in the server to when the unit of work was completed. This includes time spent waiting for resources to become available as well as time spent using available resources.

When using response time as the performance grade, the resulting performance grade is not very stable, especially when workloads are high. Small changes in the workload, such as in response to load balancing requests, can generate large changes in the performance grade. The performance grade values generated will tend to oscillate and converge to a desired value. The oscillations may be dampened by remembering the previously published performance grade and averaging the new grade with the previous grade.

In general, a “momentum” term may be introduced to control the amount of oscillation dampening and the rate of convergence:
new=(momentum*old+current)/(1+momentum).

Using the response time in this fashion is attractive because it does not require estimating system utilization or figuring out which resources a service is using. So this policy is more likely to work across a broad range of workloads. On the other hand, this approach tends to respond to changes in the overall behavior of a system more slowly than the bandwidth metric does.

When this policy is used, the system will attempt to maintain throughput/response_time constant across all instances. Essentially, this will attempt to queue the same amount of work at each instance: At any point in time, if no new work came into the system, all of the instances would complete the currently queued work at the same time.

Spare Capacity

Another possible service level goal is to estimate the spare capacity of each instance and publish that as the performance grade. One definition of spare capacity is the number of units of work that an instance could have performed during a measurement interval had there been work to perform. That is, estimate the idleness of the instance and divide that by the amount of time that it takes to complete a unit of work, not counting time spent waiting for resources.

If units of work are waiting for resources, then the idleness of the instance will be zero, so the calculation can be simplified by simply dividing the estimated idleness of the instance by the average response time of units of work executed at the instance.

Like the Response Time service level goal, the Spare Capacity goal has a tendency to generate oscillating performance grades. Thus, it is desirable to smooth out the oscillations by remembering the previously published performance grade and averaging that with the newly measured performance grade.

Adjustments

The computations described above may be adjusted in various fashions. For example, it is desirable to send a small amount of work to each instance in order to measure the performance of the instance. Also, it may be desirable to strongly avoid some instances in certain conditions (such as when the CPU is 100% busy, or all memory has been allocated, etc.) These types of adjustments will generally introduce oscillations when boundaries are reached and are thus more appropriate for those service level goals which explicitly dampen oscillations.

Also, performance grades should be values greater than zero. It may be necessary to adjust a grade of zero up slightly, or to use a slightly different computation. For example, when estimating spare capacity it may be desirable to use the formula “(% free+0.01)/elapsed_time” instead of “% free/elapsed_time”.

Generally, the server will want to estimate a performance grade for instances that are marked UNKNOWN. When estimating a performance grade, the server will generally assume that an UNKNOWN instance is similar to other instances whose performance grades can be computed. If performance grades cannot be computed for any instances, then the performance grade may be set to a constant non-zero value.

The server may be able to obtain good measurements for some, but not all, of the performance metrics it uses to compute a performance grade for an instance. In this case, the server may wish to estimate values for the missing performance metrics based on the behavior of other instances and then calculate the performance grade using the estimated metrics. For example, when estimating spare capacity for a new instance of a service, it may be possible to measure the idleness of the instance quite well, but not yet possible to measure the elapsed time at that instance because no work has yet been sent to the instance. In this case, the spare capacity of the UNKNOWN node could be estimated to be the average spare capacity of the known nodes; or, the elapsed time of the UNKNOWN node could be estimated as the same as the average elapsed times of the known nodes, and then divide the measured idleness by the estimated elapsed time.

When there are instances which are VIOLATING their service level agreements, it may be desirable to adjust performance grades. The server will generally want to distinguish between the case where all instances are VIOLATING (or about to violate) because the demand for the service is too high, and the case where one or a small number of instances are VIOLATING but other instances are working well.

The server may want to look at the performance metric that is being violated and compute the standard deviations of the performance metric across instances. VIOLATING instances whose performance metric is multiple standard deviations away from the average performance metric may have their performance grade forced to a very low value.

The performance metric used to compute outlying violators need not be the same as any of the performance metrics used to compute the performance grade. For example, if the service level goal may be BANDWIDTH, but the service level agreement may require that the response time stay below, say, 5 seconds. In this case, if the average response time was 3 seconds with a standard deviation of 3 seconds, the performance grade of an instance with a 20 second response time may be forced to a very small value.

Publishing Performance Grades

The server may publish performance grades to its clients in various fashions. In one embodiment, each client subscriber subscribes to service events, where the event payload contains a performance grade for each instance offering the service. A separate event is published for each service. The posting process acquires these data once for all active services, as described in reference to FIG. 2, and then posts an event per service.

As discussed, in one embodiment notification service daemon 118 has a publisher/subscriber relationship with event handler 120, through which certain event information that is received by daemon 1118 from database server 104 is transmitted to event handler 120. In response to receiving event information from daemon 118, event handler 120 invokes a method of connection pool manager 114, passing along the event type and property, which are described hereafter.

In one embodiment, a message format that is used for communicating service performance information in an event payload, comprises name/value pairs. Specifically, a service event may comprise the following:
Event Type=performance grades (e.g., “Database/Service/Grades/$service_name”);
Version=version number of the publication protocol;
Database name=unique name identifying database;
Grades tuple (repeating for plurality of instances offering service)=instance name, flag (i.e., GOOD, VIOLATING, NODATA, UNKNOWN), grade (i.e., work distribution percentage); and
Timestamp=time event was calculated at the server.

Different techniques may be used to determine the frequency with which performance grades are published. In one embodiment, performance grades may be published at regularly scheduled intervals (e.g. every 30 seconds). In another embodiment, performance grades are only published when they change significantly. In another embodiment, performance grades are generated frequently (e.g. every 3 seconds), and only published when they change significantly, or if they haven't been published recently. The rate at which performance grades are published may also be made dependent on the work load, i.e., infrequent publications at low work loads and frequent publications at high work loads.

Using Performance Grades

A client may use performance grades, in addition to other information available to the client to decide how to route each unit of work. In one embodiment, the client would use information available to the client to select which instances are eligible to receive the work, use the performance grades to decide how much work to send to the eligible instances, and select an eligible instance based on those percentages.

For example, the client might pay attention to which instances the client currently had idle connections. Or the client might implement a form of locality of reference, which would restrict the collection of eligible instances. After a set of eligible instances have been selected, if some of those instances have a NODATA performance grade and others do not, the NODATA instances would be eliminated from consideration.

The fraction of the work that the client should send to each of the remaining eligible instances is given by computing the performance grade of an instance divided by the sum of the performance grades of all instances. The client can then use a random number generator or other technique to select an eligible instance such that the probability of selecting an instance is equal to the faction of work that should be sent to that instance.

The client may need to perform some amount of work to make it likely that instances can be considered eligible. For example, in a connection pool, the client may close connections to instances that have a large number of idle connections, and open connections at instances that have few idle connections. Or the client may decide to close idle connections and create new connections to try and keep the number of open connections to each instance proportional to the performance grade of the instance.

Depending on the protocol defined between the client and server, the client may need to estimate the performance grade of instances that are marked with the UNKNOWN or NODATA flags. Since NODATA instances will only be used when all eligible instances have NODATA, these instances can be set to have a constant performance grade, for example, 1. If all instances are marked UNKNOWN or NODATA, then the UNKNOWN instances can have their performance grade set to a constant value as well. Otherwise, the client should set the performance grade of UNKNOWN instances to the average performance grade of GOOD and VIOLATING instances.

A Method for Determining Work Routing

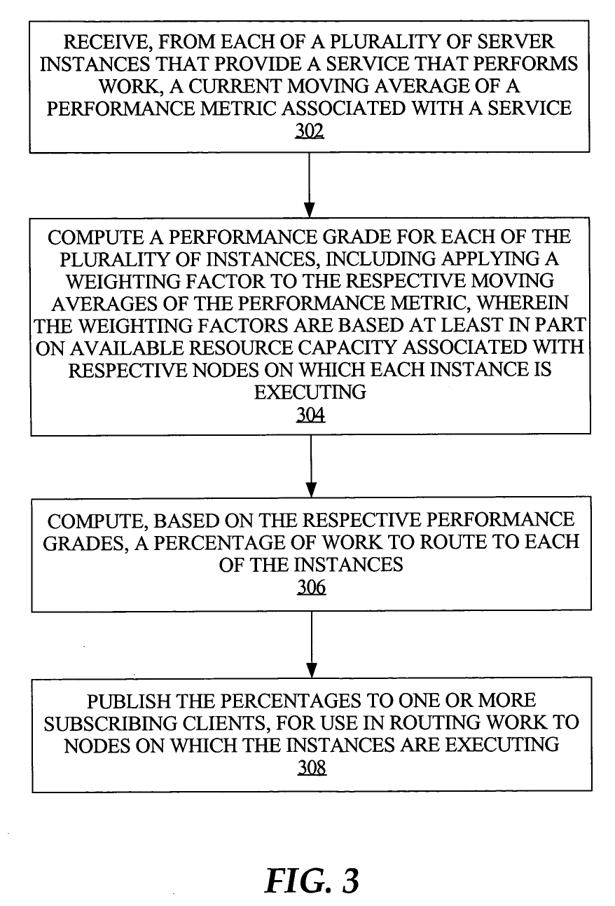

FIG. 3 is a flow diagram that illustrates a method for determining how much work to route to nodes in a distributed computing system, according to an embodiment of the invention. The distributed computing system comprises a plurality of computing nodes that each hosts a server instance that provides a service that performs work, as described in reference to FIG. 1. In some contexts, such distributed computing systems are also referred to as computing clusters and/or computing grids. In one embodiment, the method depicted in FIG. 3 is performed by a software application executing on an electronic computing system, such as computer system 400 of FIG. 4. For example, the method may be performed by a database server, such as any of instances 108a-108n of FIG. 1 or instances 201a-202n of FIG. 2.

At block 302, receive, from each of a plurality of the server instances, a current moving average of a performance metric associated with a service. For example, manageability monitor 203a of instance 202a of server 202 (FIG. 2) receives the moving average of the completed work per second, or of the elapsed time for completed calls, from each of the manageability monitors 203b-203n of instances 202b-202n. Such information may be received, for example, via an inter-process communication mechanism.

At block 304, compute a performance grade for each of the plurality of instances. In one embodiment, computation of the performance grade includes applying one or more weighting factors to the respective moving averages of the performance metric. The weighting factors are based, at least in part, on the available resource capacity associated with the respective nodes on which each instance is executing. As described herein for embodiments of the invention, the weighting factors may be based on any one or more of the available CPU processing, 10 processing and network intercommunication processing that is available from/to each node. Further as described herein, the weighting factor may be further based on the resource demand for the service, i.e., the amount of resources required by the service. For example, the weighting factors may be based on any one or more of the required CPU processing, 10 processing, and network intercommunication processing that is required to execute the service to perform work.

At block 306, compute, based on the respective performance grades, a percentage of work to route to each of the instances. As described herein, the performance grades for each instance may be normalized relative to the plurality of instances, so that percentages are derived which advise distribution of work efficiently and intelligently across the nodes. For example, the service time and/or throughput associated with each node may be computed as described herein, depending on the service goal, and normalized to derive respective work distribution percentages in accordance with the goal.

At block 308, publish the percentages to one or more subscribing clients so that the clients can use the advise contained in the percentages to route work intelligently among the system nodes. For example, goodness events may be queued and published via a notification system, such as notification service daemon 118 and event handler 120 of FIG. 1.

Implementation Mechanisms

The approach for runtime load balancing of work across a clustered computing system, as described herein, may be implemented in a variety of ways and the invention is not limited to any particular implementation. The approach may be integrated into a system or a device, or may be implemented as a stand-alone mechanism. Furthermore, the approach may be implemented in computer software, hardware, or a combination thereof.

Hardware Overview

FIG. 4 is a block diagram that depicts a computer system 400 upon which an embodiment of the invention may be implemented. Computer system 400 includes a bus 402 or other communication mechanism for communicating information, and a processor 404 coupled with bus 402 for processing information. Computer system 400 also includes a main memory 406, such as a random access memory (RAM) or other dynamic storage device, coupled to bus 402 for storing information and instructions to be executed by processor 404. Main memory 406 also may be used for storing temporary variables or other intermediate information during execution of instructions to be executed by processor 404. Computer system 400 further includes a read only memory (ROM) 408 or other static storage device coupled to bus 402 for storing static information and instructions for processor 404. A storage device 410, such as a magnetic disk or optical disk, is provided and coupled to bus 402 for storing information and instructions.

Computer system 400 may be coupled via bus 402 to a display 412, such as a cathode ray tube (CRT), for displaying information to a computer user. An input device 414, including alphanumeric and other keys, is coupled to bus 402 for communicating information and command selections to processor 404. Another type of user input device is cursor control 416, such as a mouse, a trackball, or cursor direction keys for communicating direction information and command selections to processor 404 and for controlling cursor movement on display 412. This input device typically has two degrees of freedom in two axes, a first axis (e.g., x) and a second axis (e.g., y), that allows the device to specify positions in a plane.

The invention is related to the use of computer system 400 for implementing the techniques described herein. According to one embodiment of the invention, those techniques are performed by computer system 400 in response to processor 404 executing one or more sequences of one or more instructions contained in main memory 406. Such instructions may be read into main memory 406 from another machine-readable medium, such as storage device 410. Execution of the sequences of instructions contained in main memory 406 causes processor 404 to perform the process steps described herein. In alternative embodiments, hard-wired circuitry may be used in place of or in combination with software instructions to implement the invention. Thus, embodiments of the invention are not limited to any specific combination of hardware circuitry and software.

The term “machine-readable medium” as used herein refers to any medium that participates in providing instructions to processor 404 for execution. Such a medium may take many forms, including but not limited to, non-volatile media, volatile media, and transmission media. Non-volatile media includes, for example, optical or magnetic disks, such as storage device 410. Volatile media includes dynamic memory, such as main memory 406. Transmission media includes coaxial cables, copper wire and fiber optics, including the wires that comprise bus 402. Transmission media can also take the form of acoustic or light waves, such as those generated during radio-wave and infra-red data communications.

Common forms of machine-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, and EPROM, a FLASH-EPROM, any other memory chip or cartridge, a carrier wave as described hereinafter, or any other medium from which a computer can read.

Various forms of machine-readable media may be involved in carrying one or more sequences of one or more instructions to processor 404 for execution. For example, the instructions may initially be carried on a magnetic disk of a remote computer. The remote computer can load the instructions into its dynamic memory and send the instructions over a telephone line using a modem. A modem local to computer system 400 can receive the data on the telephone line and use an infra-red transmitter to convert the data to an infra-red signal. An infra-red detector can receive the data carried in the infra-red signal and appropriate circuitry can place the data on bus 402. Bus 402 carries the data to main memory 406, from which processor 404 retrieves and executes the instructions. The instructions received by main memory 406 may optionally be stored on storage device 410 either before or after execution by processor 404.

Computer system 400 also includes a communication interface 418 coupled to bus 402. Communication interface 418 provides a two-way data communication coupling to a network link 420 that is connected to a local network 422. For example, communication interface 418 may be an integrated services digital network (ISDN) card or a modem to provide a data communication connection to a corresponding type of telephone line. As another example, communication interface 418 may be a local area network (LAN) card to provide a data communication connection to a compatible LAN. Wireless links may also be implemented. In any such implementation, communication interface 418 sends and receives electrical, electromagnetic or optical signals that carry digital data streams representing various types of information.

Network link 420 typically provides data communication through one or more networks to other data devices. For example, network link 420 may provide a connection through local network 422 to a host computer 424 or to data equipment operated by an Internet Service Provider (ISP) 426. ISP 426 in turn provides data communication services through the world wide packet data communication network now commonly referred to as the “Internet” 428. Local network 422 and Internet 428 both use electrical, electromagnetic or optical signals that carry digital data streams. The signals through the various networks and the signals on network link 420 and through communication interface 418, which carry the digital data to and from computer system 400, are exemplary forms of carrier waves transporting the information.

Computer system 400 can send messages and receive data, including program code, through the network(s), network link 420 and communication interface 418. In the Internet example, a server 430 might transmit a requested code for an application program through Internet 428, ISP 426, local network 422 and communication interface 418.

The received code may be executed by processor 404 as it is received, and/or stored in storage device 410, or other non-volatile storage for later execution. In this manner, computer system 400 may obtain application code in the form of a carrier wave.

Extensions and Alternatives

Alternative embodiments of the invention are described throughout the foregoing description, and in locations that best facilitate understanding the context of the embodiments. Furthermore, the invention has been described with reference to specific embodiments thereof. It will, however, be evident that various modifications and changes may be made thereto without departing from the broader spirit and scope of the invention. For example, embodiments of the invention are described herein in the context of a database server; however, the described techniques are applicable to any distributed computing system over which system connections are allocated or assigned, such as with a system configured as a computing cluster or a computing grid. Therefore, the specification and drawings are, accordingly, to be regarded in an illustrative rather than a restrictive sense.

In addition, in this description certain process steps are set forth in a particular order, and alphabetic and alphanumeric labels may be used to identify certain steps. Unless specifically stated in the description, embodiments of the invention are not necessarily limited to any particular order of carrying out such steps. In particular, the labels are used merely for convenient identification of steps, and are not intended to specify or require a particular order of carrying out such steps.

1. A computer-implemented method for determining how much work to route to computing nodes in a computing system that comprises a plurality of nodes that each hosts a server instance that provides a service that performs work, the method comprising:
based on a current moving average of a performance metric, from each of a plurality of server instances that provide a particular service, that is associated with the particular service, computing a performance grade for each of the plurality of server instances; and
computing, based on the respective performance grades, a percentage of work to route to each of the plurality of server instances.

2. The method of claim 1, further comprising:
publishing the percentages to one or more subscribing clients; and
routing work, by at least one of the subscribing clients and based on the percentages, to particular nodes in the computing system.

3. The method of claim 2, wherein the step of publishing includes posting events to an event queue, wherein each event is associated with one particular service.

4. The method of claim 2, wherein the step of publishing the performance grades includes periodically publishing the percentages, wherein the period is based on a rate at which requests for the service are received.

5. The method of claim 2, further comprising:
publishing a flag to the one or more subscribing clients, in association with each percentage, wherein the flag indicates any one from the group consisting of (a) the performance grade was computed for this instance, (b) the service on this instance is violating a service level agreement associated with the service, (c) the performance grade was not computed for this instance, and (d) the performance grade was not computed for this instance, but work can be routed to this instance; and
routing work, by at least one of the subscribing clients and based on the percentage and associated flags, to nodes in the computing system.

6. The method of claim 1, wherein the step of computing performance grades includes computing a performance grade based on a performance metric associated with response time of the service as provided by the server instance.

7. The method of claim 1, wherein the step of computing performance grades includes computing a performance grade based on a performance metric associated with throughput of the respective node on which the server instances is executing.

8. The method of claim 1, wherein the step of computing performance grades includes computing a performance grade based on a performance metric associated with spare capacity of the respective node on which the server instances is executing.

9. The method of claim 1,
wherein the step of computing performance grades includes applying one or more weighting factors to the respective moving averages of the performance metric;
wherein the weighting factors are based, at least in part, on any one or more from the group consisting of available CPU processing, available 10 processing, and available network communication processing within the computing system.

10. A machine-readable medium carrying one or more sequences of instructions which, when executed by one or more processors, causes the one or more processors to perform the method recited in claim 1.

11. A machine-readable medium carrying one or more sequences of instructions which, when executed by one or more processors, causes the one or more processors to perform the method recited in claim 2.

12. A machine-readable medium carrying one or more sequences of instructions which, when executed by one or more processors, causes the one or more processors to perform the method recited in claim 3.

13. A machine-readable medium carrying one or more sequences of instructions which, when executed by one or more processors, causes the one or more processors to perform the method recited in claim 4.

14. A machine-readable medium carrying one or more sequences of instructions which, when executed by one or more processors, causes the one or more processors to perform the method recited in claim 5.

15. A machine-readable medium carrying one or more sequences of instructions which, when executed by one or more processors, causes the one or more processors to perform the method recited in claim 6.

16. A machine-readable medium carrying one or more sequences of instructions which, when executed by one or more processors, causes the one or more processors to perform the method recited in claim 7.

17. A machine-readable medium carrying one or more sequences of instructions which, when executed by one or more processors, causes the one or more processors to perform the method recited in claim 8.

18. A machine-readable medium carrying one or more sequences of instructions which, when executed by one or more processors, causes the one or more processors to perform the method recited in claim 9.
